(19) United States
(12) Patent Application Publication
(10) Pub. No.: US 2007/0104255 A1
(43) Pub. Date: May 10, 2007

(54) Barker code detector

(75) Inventor: Arie Geert Cornelis Koppelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,460

(22) PCT Filed: Jun. 21, 2004
(86) PCT No.: PCT/IB04/50943

§ 371 Date: Dec. 20, 2005

(30) Foreign Application Priority Data
Jun. 25, 2003 (EP) 03101879.9

(51) Int. Cl. H04B 1/00

(52) U.S. Cl. 375/150

(57) ABSTRACT

Apparatus for determining whether or not a received data sequence is Barker spreaded, comprising sampling means (10) for sampling the received sequence, a Barker correlator (12), means (14) for determining the magnitude of the correlation result, filter means (16) for filtering the correlation results to create a data set consisting of the correlation result of K subsequent data bits, where K is a quality parameter and comprises an integer greater than 1, means (20) for deriving a parameter L by determining the difference between a maximal correlation result and a minimal correlation result normalized by the minimal correlation result, and means (22) for comparing L with a predetermined threshold value to determine if the received signal is a Barker spreaded sequence.

This invention relates generally to spread spectrum code position modulation communications and, more particularly, to a method and apparatus for detecting whether or not a received data sequence is Barker spreaded after transmission thereof over a dispersive transmission medium, and a receiver employing the same.

The concept of wireless communication in computer systems configured as local area networks (LANs) has been well known for many years, but interest therein was limited until the release of the unlicensed 2.4 GHz unlicensed band for industrial, scientific and medical (ISM) applications.

Wireless LAN products most often employ either direct sequence spread spectrum (DSSS) or frequency hopping spread spectrum (FHSS) techniques to communicate between roaming mobile stations and network access points. A distinguishing feature of the spread spectrum technique is that the modulated output signals occupy a much greater transmission bandwidth than the baseband information bandwidth required. The spreading is achieved by encoding each data bit in the baseband information using a codeword or symbol that has a much higher frequency than the baseband information bit rate. The resultant “spreading” of the signal across a wider frequency bandwidth results in comparatively lower power spectral density, so that other communication systems are less likely to suffer interference from the device that transmits the spread spectrum signal. It also makes the spread signal harder to detect and less susceptible to interference (i.e. harder to jam).

Both DSSS and FHSS techniques employ a pseudo-random codeword known to the transmitter and the receiver, to spread the data and make it more difficult to detect by receivers lacking the codeword. The codeword consists of a sequence of “chips” having values of −1 and +1 (polar) or 0 and 1 (non-polar) that are multiplied by (or XORd with) the information bits to be transmitted. Accordingly, a logic ‘0’ information bit may be encoded as a first predetermined codeword, and a logic ‘1’ information bit may be encoded as a second predetermined codeword sequence.

Many wireless networks conform to the IEEE 802.11 standard, which employs the well-known Barker code to encode and spread the data. The Barker codeword consists of 11 chips having the sequence ‘00011101101’ or ‘+++−−−+−−+−’. One entire Barker codeword sequence, or symbol, is transmitted in the time period occupied by a single binary information bit. Thus, if the symbol (or Barker sequence) rate is 1 MHz, the underlying chip rate for the eleven chips in the sequence is 11 MHz. By using the 11 MHz chip rate signal to modulate the carrier wave, the spectrum occupied by the transmitted signal is eleven times greater. Accordingly, the recovered signal in the receiver, after demodulation and correlation, comprises a series of inverted Barker sequences representing, for example, logic ‘1’ information bits, and non-inverted Barker sequences representing, for example, logic ‘0’ information bits.

In general, standard wireless local area networks employ DSSS for 1 and 2 Mb/s modes and Complementary Code Keying (CCK) codes for 5.5 and 11 Mb/s modes. The IEEE 802.11b standard, for example, uses 64 CCK chipping sequences to achieve 11 Mb/s. Rather than using the Barker code, CCK uses a series of codes called Complementary Sequences. Because there are 64 unique codewords that can be used to encode the signal, up to 6 bits can be represented by any one particular codeword (instead of the one bit represented by a Barker symbol).

For all modes, data to be transmitted is encapsulated or “packed” into frames at the transmitter, and decapsulated or “unpacked” at the receiver. Each frame or packet comprises, among other fields, a preamble which provides a mechanism for establishing synchronization (SYNC) between the packing and unpacking operations and a header. For all IEEE 802.11b modes (described above), at least the preamble and the header of an IEEE 802.11b packet are spreaded with an 11-bit Barker sequence.

It will be appreciated by a person skilled in the art that, in order to make reception of an IEEE 802.11b-compliant data packet possible, an IEEE 802.11b compliant receiver has to be enabled when an IEEE 802.11b compliant signal is detected. Means are therefore required for detecting that an IEEE 802.11b -compliant signal has been received, so that the appropriate receiver can be enabled.

It is known to make use of the fact that at least the preamble and header of an IEEE 802.11b compliant packet are spreaded with an 11-bit Barker sequence. By cross-correlating the received signal with the 11-bit Barker sequence, one can expect to get large correlation results when the 11-bit Barker sequence is synchronous with the 11-bit Barker sequence in the spreaded signal, and small correlation results otherwise. Thus, within a window of 11 received bits, one can expect one large correlation value, and that large correlation value will occur periodically, i.e. with a period of 11 bits.

However, certain problems are associated with the use of a radio transmission link, particularly for LANs in an indoor environment. One such problem is multipath fading, the effects of which can cause more than one significantly large correlation value to occur within a single 11-bit period. This makes it more difficult to distinguish between Barker spreaded signals and other kinds of signals.

In a known arrangement, the presence of a Barker spreaded signal can be demonstrated by testing both the occurrence of large correlation values and the periodicity of those large correlation values. However, using this method, the decision time (i.e. whether or not a Barker signal is present) is variable. Particularly in the case of the “No Barker signal present” situation, it can take a long time before this method declares that there is no Barker signal present For this reason, a so-called “timeout” function needs to be defined.

U.S. Pat. No. 5,131,006 describes an arrangement for carrier detection and antenna selection in a wireless local area network receiver suitable for receiving a spread spectrum code position modulated signal. In the described receiver, correlator outputs are utilized in an integrator and register circuit to provide correlator output sample values integrated over a plurality of symbol intervals. These values are stored in registers, the contents of which are used to determine a peak value and a total value, which values are applied to a spike quality determination circuit including a look-up table. The resultant spike quality output value represents the quality of the received signal and is used for carrier detection and for antenna selection.

We have now devised an improved arrangement.

In accordance with present invention, there is provided a method of determining if a received data sequence is a Barker spreaded sequence, the method comprising the steps of correlating said received data sequence, performing a filtering operation to create a data set consisting of the sum of the correlation result of K subsequent data bits, where K is a quality parameter and comprises an integer greater than 1, deriving a parameter L by determining the difference between a maximal correlation result and a minimal correlation result normalized by the minimal correlation result, and comparing the parameter L with a predetermined threshold value to determine if said received signal is a Barker spreaded sequence.

Also in accordance with the present invention, there is provided apparatus for determining if a received data sequence is a Barker spreaded sequence, the apparatus comprising means for correlating said received data sequence, means for performing a filtering operation to create a data set consisting of the sum of the correlation result of K subsequent data bits, where K is a quality parameter and comprises an integer greater than 1, means for deriving a parameter L by determining the difference between a maximal correlation result and a minimal correlation result normalized by the minimal correlation result, and means for comparing the parameter L with a predetermined threshold value to determine if said received signal is a Barker spreaded sequence.

In a preferred embodiment, the step of correlating the received sequence comprises deriving a signal y(kT+n) using the formula:

$$y ( kT + n ) = {\sum }_{i = 0}^{T - 1} {b}_{i}^{*} r ( kT + n - i ) \qquad ( 1 )$$

where bᵢ* is the equivalent complex conjugated Barker sequence, r(kT+n) is a sampled received data sequence, k=0, 1, . . . , and T is the sampling rate at which the received sequence is sampled prior to application thereof to the correlator. Preferably, the magnitude of y(kT+n) is obtained prior to the step of performing the filtering operation, i.e. s(kT+n)−|y(kT+n)|.

In a preferred embodiment, the filtering operation comprises the calculation of a running average of the correlation results, using the formula:

$${}_{\hat{s} K} ( n ) {=}_{K}^{1} {\sum }_{i = 1}^{K} s ( i T + n ) , for n = 0 , … , T - 1 \qquad ( 2 )$$

In an exemplary embodiment of the present invention, L is calculated using the formula:

$$L = \frac{{max}_{n \hat{s} K} ( n ) - {min}_{n \hat{s} K} ( n )}{{min}_{n \hat{s} K} ( n )} \qquad ( 3 )$$

and a decision signal indicating the presence of a Barker sequence is output if L>T, and a decision indicating no Barker sequence is output otherwise, where T is a predetermined threshold value.

These and other aspects of the present invention will be apparent from, and elucidated with reference to, the embodiment of the present invention described hereinafter.

An embodiment of the present invention will now be described by way of example only and with reference to the accompanying drawings, in which:

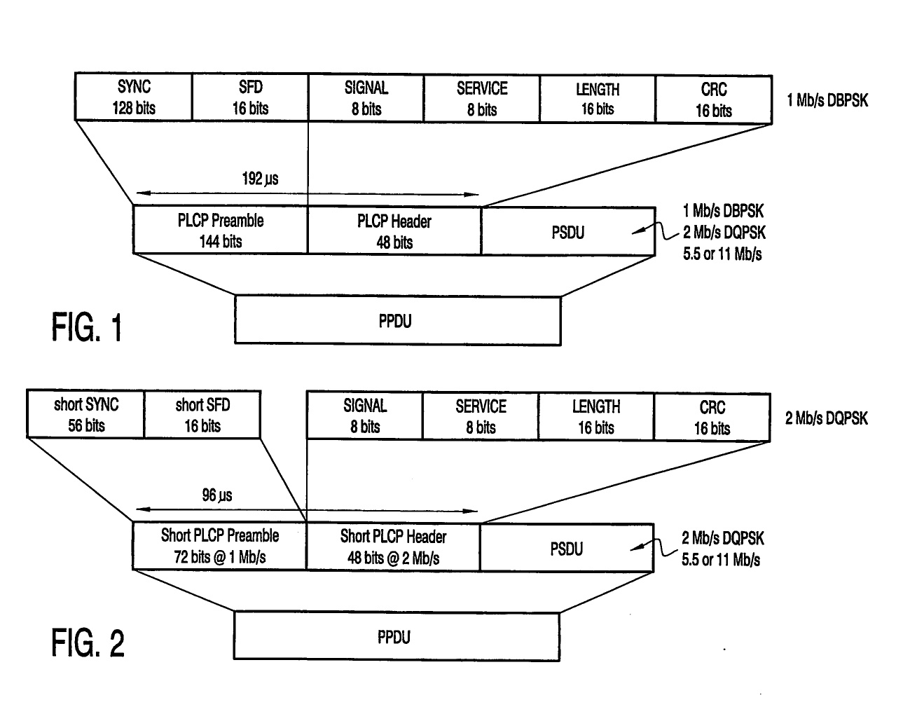

FIG. 1 illustrates a long frame format used in the IEEE 802.11b standard for Wireless Local Area Networks;

FIG. 2 illustrates a short frame format used in the IEEE 802.11b standard for Wireless Local Area Networks;

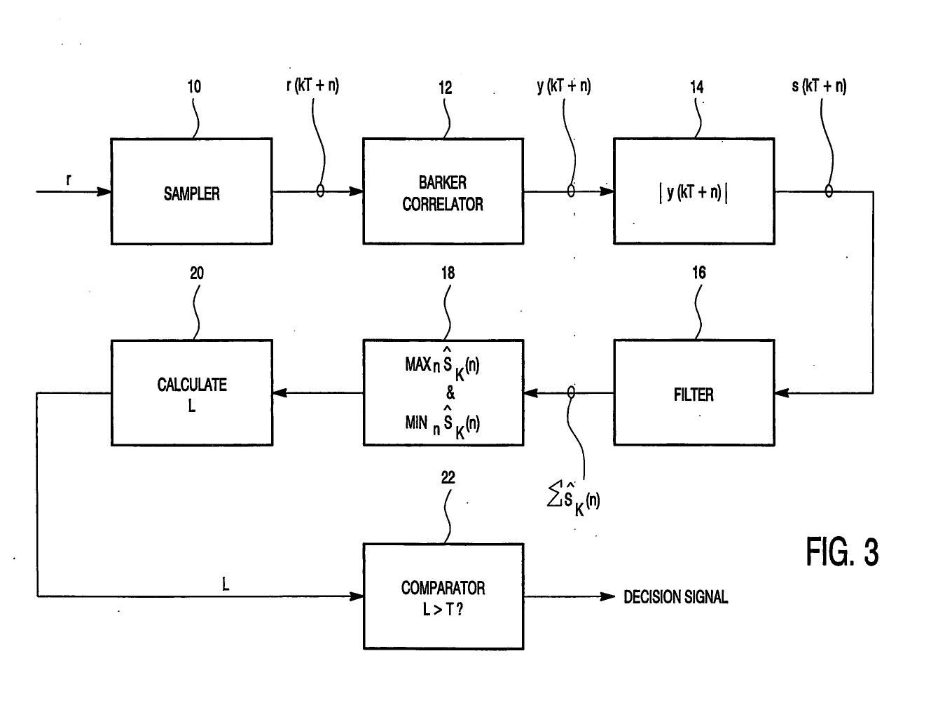

FIG. 3 is a schematic block diagram illustrating the primary elements of apparatus according to an exemplary embodiment of the present invention;

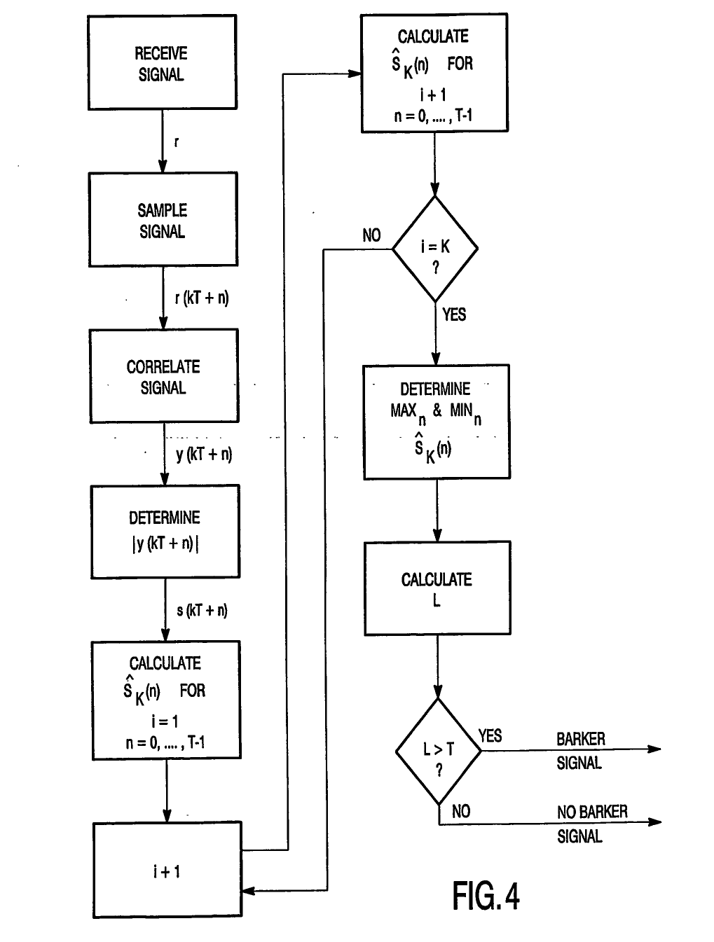

FIG. 4 is a schematic flow diagram illustrating the primary steps of a method according to an exemplary embodiment of the present invention;

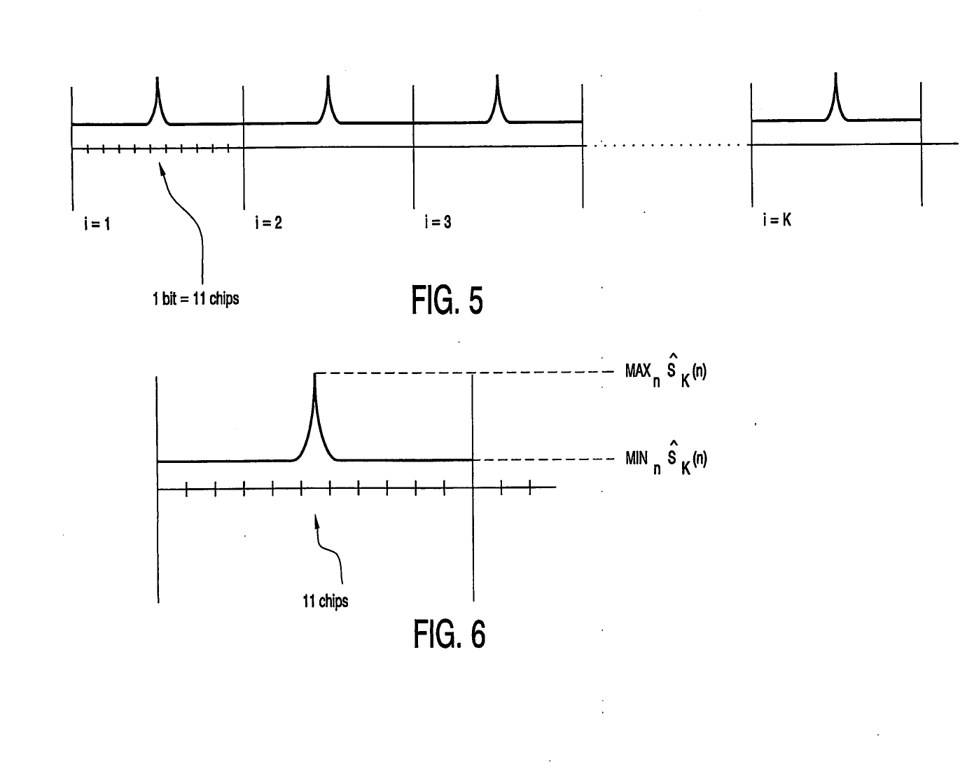

FIG. 5 is a schematic diagram illustrating the nature of the signal s_{K}(n) for i=1 to K;

FIG. 6 is a schematic diagram illustrating the manner in which maxₙ(average s_{K}(n)) and minₙ(average s_{K}(n)) are determined;

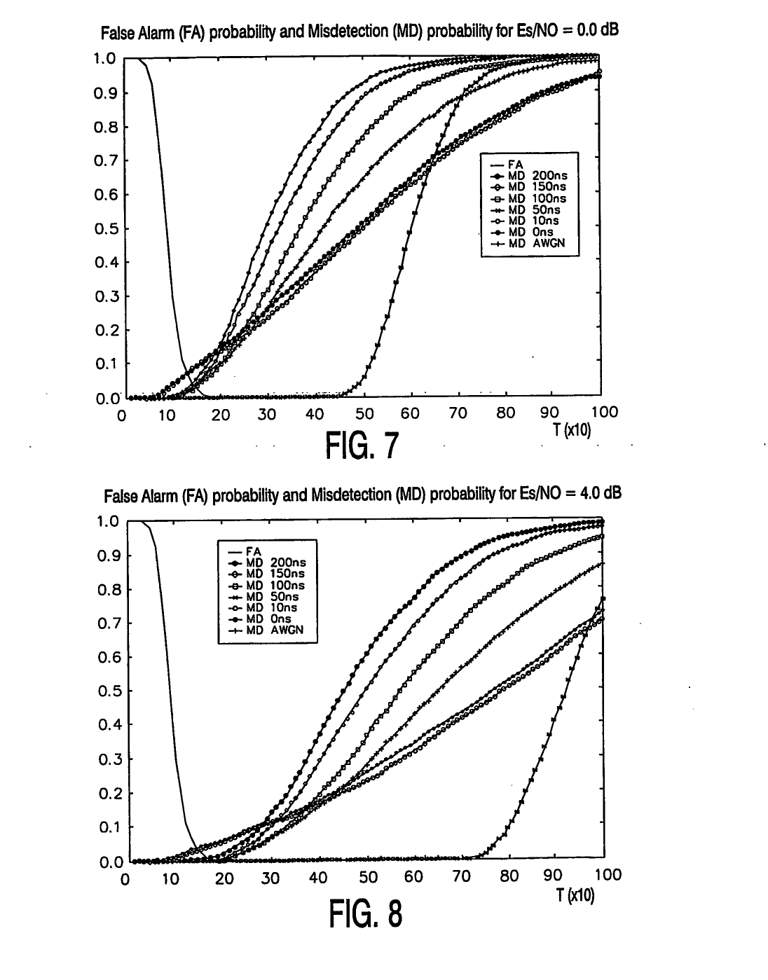

FIG. 7 is a graph illustrating the false alarm probability and misdetection probability for Eₛ/N₀=0 dB; and

FIG. 8 is a graph illustrating the false alarm probability and misdetection probability for Eₛ/N₀=4 dB.

The IEEE 802.11b standard for Wireless Local Area Networks describes two physical frame formats, namely the long frame format illustrated in FIG. 1 of the drawings, and the optional short frame format illustrated in FIG. 2.

The SYNC field in the long frame format consists of 128 bits. These 128 bits comprise an all-one sequence, scrambled with a data scrambler that uses the initial seed 1101100. The Start Field Delimiter (SFD) indicates the start of PHY (Physical Layer)—dependent parameters and is equal to 1111001110100000 (Hexadecimal F3A0), wherein the rightmost bit is transmitted first.

The SYNC field in the short frame format consists of 56 bits, comprising 56 zero bits scrambled with a data scrambler, which in this case uses the initial seed 0011011. The SFD is again a 16-bit field, but in comparison to the SFD field in the long frame format, the bits are reversed in time (Hexadecimal 05CF).

An exemplary embodiment of the present invention will now be described with reference to FIGS. 3 and 4 of the drawings.

A received signal r is applied to a sampler 10.

Let r(kT+n) be the sampled received sequence, where k=0, 1, . . . , and n=0, . . . , T−1. In case of a critical sampled sequence signal (no oversampling), we have T=11, and in case of a two times oversampled signal, we have T=22. The sampled received sequence is applied to a Barker correlator 12. The output y(kT+n) of the Barker correlator 12 is given by:

$$y ( kT + n ) = {\sum }_{i = 0}^{T - 1} {b}_{i}^{*} r ( kT + n - i ) \qquad ( 4 )$$

where bᵢ* is the equivalent (i.e. unsampled) complex conjugated Barker sequence. In general, the output of the Barker correlator 12 will be complex valued. In the Barker detector of this example of the present invention, the magnitude s(kT+n)=y(kT+n) of the correlation results is used (as illustrated by block 14 in FIG. 3). In one period, there are T correlation results i.e. s(kT+n) for n=0, . . . , T−1 (as illustrated in FIG. 5 of the drawings). The Barker detector of this exemplary embodiment of the present invention employs a filtered version ŝₖ(n) of the correlation results, and the following filter operation (performed by block 16 in FIG. 3) is proposed:

$${}_{\hat{s} K} ( n ) {=}_{K}^{1} {\sum }_{i = 1}^{K} s ( i T + n ) , for n = 0 , … , T - 1 \qquad ( 5 )$$

With this filter 16, the expected periodicity of correlation results in case of an IEEE 802.11b compliant signal is accounted for. After some time (determined by K which is a design parameter), the filtered correlation results are used (at block 20) to derive a parameter L on which the decision as to whether or not a Barker signal is present:

$$L = \frac{{max}_{n \hat{s} K} ( n ) - {min}_{n \hat{s} K} ( n )}{{min}_{n \hat{s} K} ( n )} \qquad ( 6 )$$

For some well-chosen value of K. It will be appreciated that the maximum and minimum values of ŝₖ(n) are determined at block 18, as illustrated in FIG. 6 of the drawings.

The expectation is that L will be large if a Barker signal is present, and it will be small otherwise. The proposed decision criterion is that for some well chosen threshold T, the decision signal indicates that a Barker signal is present if L>T (block 22, FIG. 3). In order to get an impression of the performance of the proposed Barker detector we define two performance measures, i.e. the false alarm probability P_{fa} and the misdetection probability P_{md},
P_{fa}=Pr(L>T/No Barker signal present),
P_{md}=Pr(L≦T/Barker signal present) (7)

These two performance indicators are evaluated for the following channel conditions AWGN and exponential channel model with 0 (Rayleigh flat fading), 10, 50, 100, 150 and 200 ns RMS delay spread. The “No Barker signal present” situation means that only AWGN is supplied to the Barker detector. In FIG. 7 and FIG. 8, performance results are shown for Eₛ/N₀=0 dB and Eₛ/N₀=4 dB. These results are obtained by analyzing the parameter L for 2000 channel realizations and averaging the correlator results over K−10 samples.

The choice of the threshold T is a compromise between a low P_{fa} and a low P_{md} For the AWGN channel one can select a threshold such that both are significant smaller than 0.1% e.g. T=3.0. We see in the FIGS. that the range of viable thresholds increase with the signal to noise ratio.

Similar experiments can also be carried out by using a random (i.e. not Barker spreaded) signal for obtaining the false alarm probability.

In summary, in accordance with the present invention, the occurrence of large correlation results is tested by determining the difference of the maximal correlation result and the minimal correlation result normalized by the minimal correlation result.

There are several advantages associated with the present invention, including:
Periodicity checking of the correlation results (i.e. the check as to whether high correlation results occur periodically) is not required, although this can be used in addition to the present invention to further increase the reliability of the method.
The proposed method makes a decision after a fixed time period (defined by the design parameter K), as opposed to the variable decision time associated with the prior art method described above.
The derived parameter L can also be used as a channel quality indicator for antenna diversity, i.e. the antenna with the largest L can be given preference in an antenna selection process.

An embodiment of the present invention has been described above by way of example only, and it will be apparent to a person skilled in the art that modifications and variations can be made to the described embodiment without departing from the scope of the invention as defined by the appended claims. It will also be appreciated that the term “comprising” used herein does not preclude other features, “a” or “an” does not exclude a plurality, and a single processor or other unit may fulfill the functions of several means recited in the claims.

1. A method of determining if a received data sequence is a Barker spreaded sequence, the method comprising the steps of correlating said received data sequence, performing a filtering operation to create a data set consisting of the sum of the correlation result of K subsequent data bits, where K is a quality parameter and comprises an integer greater than 1, deriving a parameter L by determining the difference between a maximal correlation result and a minimal correlation result normalized by the minimal correlation result, and comparing the parameter L with a predetermined threshold value to determine if said received signal is a Barker spreaded sequence.

2. A method according to claim 1, wherein the step of correlating the received sequence comprises deriving a signal y(kT +n) using the formula:
$$y ( kT + n ) = {\sum }_{i = 0}^{T - 1} {b}_{i}^{*} r ( kT + n - i )$$
where bᵢ* is the equivalent complex conjugated Barker sequence, r(kT=n) is a sampled received data sequence, k=0,1, . . . , and T is the sampling rate at which the received sequence is sampled prior to application thereof to the correlator.

3. A method according to claim 1, wherein the magnitude of y(kT+n) is obtained prior to the step of performing the filtering operation.

4. A method according to claim 1, wherein the filtering operation comprises the calculation of a running average of the correlation results, using the formula:
$${}_{\hat{s} K} ( n ) {=}_{K}^{1} {\sum }_{i = 1}^{K} s ( i T + n ) , for n = 0 , … , T - 1$$

5. A method according to claim 1, wherein L is calculated using the formula:
$$L = \frac{{max}_{n \hat{s} K} ( n ) - {min}_{n \hat{s} K} ( n )}{{min}_{n \hat{s} K} ( n )}$$
and a decision signal indicating the presence of a Barker sequence is output if L>T, and a decision indicating no Barker sequence is output otherwise, where T is a predetermined threshold value.

6. Apparatus for determining if a received data sequence is a Barker spreaded sequence, the apparatus comprises a correlator (12) arranged to correlate said received data sequence, a filter (16) arranged to perform a filtering operation to create a data set consisting of the sum of the correlation result of K subsequent data bits, where K is a quality parameter and comprises an integer greater than 1, a calculator (20) arranged to derive a parameter L by determining the difference between a maximal correlation result and a minimal correlation result normalized by the minimal correlation result, and a comparator (22) arranged to compare the parameter L with a predetermined threshold value to determine if said received signal is a Barker spreaded sequence.

7. A decoder comprising an apparatus according to claim 6.

8. A receiver comprising a decoder according to claim 7.

9. Apparatus arranged to determine if a received data sequence is a Barker spreaded sequence by using the method of claim 1.

10. Decoder comprising an apparatus according to claim 9.

11. Receiver comprising a decoder according to claim 10.

12. A wireless local area network comprising at least one transmitter and at least one receiver according to claim 8.
